(19) United States
(12) Patent Application Publication
(10) Pub. No.: US 2026/0008516 A1
(43) Pub. Date: Jan. 8, 2026

(54) BICYCLE TRANSMISSION CONTROL SYSTEM

(71) Applicant: CLASSIFIED CYCLING BV, Antwerpen (BE)

(72) Inventor: Roëll Marie VAN DRUTEN, Eindhoven (NL)

(21) Appl. No.: 18/993,057

(22) PCT Filed: Jun. 21, 2023
(86) PCT No.: PCT/EP2023/066875

§ 371 Date: Jan. 10, 2025

(30) Foreign Application Priority Data
Jul. 12, 2022 (NL) 2032465
Sep. 22, 2022 (NL) 2033111

(51) Int. Cl. B62M 9/122; B62K 23/02

(52) U.S. Cl. CPC B62M 9/122; B62K 23/02

(57) ABSTRACT

A bicycle transmission control system for controlling a bicycle transmission, comprising a first control device comprising at least a first and a second sensing device, the first sensing device being actuatable through a first user contact surface, and the second sensing device being actuatable through a second user contact surface different from the first user contact surface, a second control device comprising at least a third and fourth sensing device, the third sensing device being actuatable through a third user contact surface. and the fourth sensing device being actuatable through a fourth user contact surface different from the third user contact surface: and a controller that is operatively connected to the sensing devices of the first and second control devices, wherein the controller is configured to control the bicycle transmission to activate a gear shift upon actuation of one of the first, second, third or fourth sensing devices.

### FIELD OF THE INVENTION

The invention relates to a bicycle transmission control system.

### BACKGROUND OF THE INVENTION

Bicycles, in particular racing bicycles, have a transmission system that traditionally includes a front derailleur and a rear derailleur, for shifting gears of the transmission system.

Control devices allows a cyclist to operate each of the derailleurs while cycling, for selecting an appropriate gear. The control devices are conveniently provided in reach of the cyclist, typically mounted at or near a grip portion of a handlebar of the bicycle, to facilitate the operation of the control device while cycling.

A control device conventionally comprises one or more shift levers which are manually operable by a user to effect a gearshift. Movement of one of the shift levers for example pulls a shift cable which connects to one of the derailleurs, causing a movement of the derailleur to shift a chain to a sprocket of a larger or smaller diameter.

Bicycles typically include two separate control devices; typically a right control device dedicated for operating the rear derailleur and a left control device for dedicated for controlling the front derailleur, or vice versa. The right control device is by convention operable by a right hand of the cyclist to operate the rear derailleur, whereas the left control device is operable by a left hand of the cyclist to operate the front derailleur.

Using the two traditional control devices for upshifting and downshifting separate transmission systems, such as a front and rear derailleur can be cumbersome, as shifting with the front derailleur typically results in a large change in transmission ratio, which may need to be compensated for by also shifting the rear derailleur to obtain at a desired consecutive change in transmission ratio.

It is therefore an object to provide a bicycle transmission control system that facilitates and improves the handling of the bicycle transmission. It is further an object to facilitate and improve the overall gear-shifting performance of the bicycle.

### SUMMARY

According to a first aspect is provided a bicycle transmission control system for controlling a bicycle transmission having a plurality of consecutive discrete bicycle transmission ratios. The bicycle transmission comprises a first transmission connected in series to a second transmission. The first transmission includes a plurality of sprockets associated with an endless drive member, such as a chain, and an electrically actuatable derailleur. The first transmission can be operated according to a plurality of selectable first transmission ratios. The second transmission includes an electrically actuatable internal hub transmission or internal crank transmission having at least two selectable second transmission ratios. The first transmission can comprise a first actuator, e.g. associated with the electrically actuatable derailleur. The second transmission can comprise a second actuator. The first transmission and the second transmission cooperate to provide the plurality of consecutive bicycle transmission ratios. First transmission ratios of the first transmission can be separated by first transmission ratio steps. Second transmission ratios of the second transmission can be separated by second transmission ratio steps. The first transmission ratio steps can be smaller than the second transmission ratio steps. The first transmission ratio steps can e.g. be 6-14%. The second transmission ratio steps can e.g. be 10-100%. Alternatively, the first transmission ratio steps can be larger than the second transmission ratio steps. Shifting from one bicycle transmission ratio to a consecutive bicycle transmission ratio may require actuation of the first transmission, the second transmission, or both. Shifting from one bicycle transmission ratio to a next higher bicycle transmission ratio may require upshifting one of the first and second transmissions in addition to downshifting the other of the first and second transmissions. Shifting from one bicycle transmission ratio to a next lower bicycle transmission ratio may require downshifting one of the first and second transmissions in addition to upshifting the other of the first and second transmissions.

The bicycle transmission control system comprises a first, a second and a third sensing device. The sensing devices are configured to receive user input. The bicycle transmission control system comprises a controller that is operatively connected to the first, second, and third sensing devices. The controller is configured to control the bicycle transmission to activate a gear shift upon actuation of one of the first, second or third sensing devices. The controller is configured to control the bicycle transmission to, upon actuation of the first sensing device, control the first and/or second transmission to activate a gear upshift to the first next higher bicycle transmission ratio. The controller is configured to control the bicycle transmission to, upon actuation of the second sensing device, control the first and/or second transmission to activate a gear downshift to the first next lower bicycle transmission ratio. The controller is configured to control the bicycle transmission to, upon actuation of the third sensing device, control only the second transmission to activate a gear shift.

Hence, the first and second sensing devices provide an intuitive control to the user for upshift and downshifting from one bicycle transmission ratio to the next. The user need not be concerned about which of the first and second transmissions needs to be controlled for achieving the desired next higher or next lower bicycle transmission ratio since the controller takes care of this. The third sensing device provides an additional control allowing shifting of the second transmission only. Such shifting of the second transmission only can relate to shifting several bicycle transmission ratio steps at once. This can allow for a bail-out in case immediate downshifting of several bicycle transmission steps is desired.

Optionally, the bicycle transmission control system further comprises a fourth sensing device. The controller is then also operatively connected to the fourth sensing devices. The controller is configured to, upon actuation of the third sensing device, control only the second transmission to activate a gear upshift to a higher transmission ratio, and, upon actuation of the fourth sensing device, control only the second transmission to activate a gear downshift to a lower transmission ratio. Thus, actuation of the third sensing device can be used for upshifting several bicycle transmission ratio steps at once, and actuation of the fourth sensing device can be used for downshifting several bicycle transmission ratio steps at once.

Optionally, the first sensing device is actuatable through a first user contact surface. Optionally, the second sensing device is actuatable through a second user contact surface different from the first user contact surface. Optionally, the third sensing device is actuatable through a third user contact surface different from the first and second user contact surface. Optionally, if present, the fourth sensing device is actuatable through a fourth user contact surface different from the first, second and third user contact surface. The first sensing device being actuatable through a first user contact surface, and the second sensing device being actuatable through a second user contact surface different from the first user contact surface avoids user confusion when actuating the first and second sensing devices and provides great control of the first and second sensing devices. The third sensing device being actuatable through a third user contact surface, and the fourth sensing device being actuatable through a fourth user contact surface different from the third user contact surface avoids user confusion when actuating the third and fourth sensing devices and provides great control of the first and second sensing devices.

Optionally, the bicycle transmission control system comprises a first control device comprising the first and the second sensing device, the first sensing device may be actuatable through the first user contact surface, and the second sensing device may be actuatable through the second user contact surface. Optionally, the bicycle transmission control system comprises a second control device comprising the third and, if present, the fourth sensing device, the third sensing device may be actuatable through the third user contact surface, and the fourth sensing device may be actuatable through the fourth user contact surface. The second control device comprising at least a third and fourth sensing device,

Thus, upshifting or downshifting a small transmission ratio step, viz. to the next higher or lower transmission ratio can be performed using the dedicated first or second sensing device, e.g. the first or second user contact surface. Upshifting or downshifting a large transmission ratio step, viz. to a transmission ratio higher/lower than the first next higher/lower transmission ratio can be performed using the dedicated third or fourth sensing device, e.g. the third or fourth user contact surface. Hence, the user has full control over the transmission system at all times.

Herein the term bicycle is used to refer to a (n at least partially) human powered vehicle, particularly a pedal powered vehicle, such as bicycles, tricycles, quadricycles, and the like, also including such vehicles with electric power assistance.

Optionally, the first control device is configured to be operable with a user's right hand and the second control device is configured to be operable with the user's left hand, or vice versa the first control device is configured to be operable with a user's left hand and the second control device is configured to be operable with the user's right hand. Hence, the user has full bimanual control over the transmission system at all times

Optionally, the first control device is configured to be mounted at a bicycle handlebar right grip portion and the second control device is configured to be mounted at a bicycle handlebar left grip portion, or vice versa the first control device is configured to be mounted at a bicycle handlebar left grip portion and the second control device is configured to be mounted at a bicycle handlebar right grip portion.

For example in case the second transmission has more than two second transmission ratios, the controller may be configured to allow user setting of which second transmission ratio the third, and if present fourth, sensing device are associated with, e.g. using an app on a mobile device, such as a smartphone.

Optionally, the first user contact surface includes a first user actuatable button, and the second user contact surface includes a separate second user actuatable button. Optionally, the third user contact surface includes a third user actuatable button, and the fourth user contact surface includes a separate fourth user actuatable button. The use of separate buttons provides simple and non-confusing user control.

Optionally, the first control device is a first grip shifter and/or the second control device is a second grip shifter. The first sensing device may be configured for detecting rotation of the first grip shifter in a first rotation direction. The second sensing device may be configured for detecting rotation of the first grip shifter in an opposite second rotation direction. The third sensing device may be configured for detecting rotation of the second grip shifter in a third rotation direction. The fourth sensing device may be configured for detecting rotation of the second grip shifter in an opposite fourth rotation direction.

Optionally, the controller is fixable to or integratable in a bicycle handlebar. The controller can e.g. be configured to be mounted in an end of the bicycle handlebar. Hence, convenient placement of the controller can be provided.

Optionally, the controller includes or is connected to a transmitter for wirelessly transmitting a gear shift command to the bicycle transmission system. The transmitter can e.g. also be mounted in the end of the bicycle handlebar. The transmitter may include an antenna for transmitting a wireless signal. It will be appreciated that the transmitter may be considered to be part of the controller of the control device. The controller may communicate with an actuator or multiple actuators for example, by means of the transmitter. The controller may for instance transmit, with the transmitter, a control signal that is associated with an upshift command to an actuator, which actuator, in response to the control signal, brings about an upward gearshift. The controller may transmit multiple control signals to multiple actuators simultaneously and/or sequentially, e.g. in response to a single signal received from the sensing device. The control signal is preferably transmitted by the transmitter wirelessly, but it will be appreciated that the control signal can also be transmitted by wire.

Optionally, the controller includes or is connected to an electric power source, such as a battery. The power source can e.g. also be mounted in the end of the bicycle handlebar. The controller and/or the transmitter and/or the power source can form a single module, e.g. configured to be placed in the end of the bicycle handlebar.

Optionally, the first and a second control devices are wiredly connected to the controller, e.g. when the controller (and/or transmitter and/or power source) is mounted in the end of the bicycle handlebar.

The bicycle transmission is a arranged between a system input and a system output and is operable according to multiple bicycle transmission ratios. The bicycle transmission includes the first transmission which is operable according to the plurality of first transmission ratios. The first transmission can comprise the first actuator for switching from one first transmission ratio to another. The first transmission ratios can include a 1:1 coupling. The bicycle transmission also includes the second transmission which is operable according to the plurality of second transmission ratios. The second transmission can comprise the second actuator for switching from one second transmission ratio to another. The first and second transmissions are couplable to each other, for example using an axle, shaft, chain, clutch or other suitable device. The first and second transmissions can be coupled in parallel and/or in series. The controller is operatively connected to the sensing devices. The controller is configured to control the first actuator and/or the second actuator upon receiving a signal from the one or more sensing devices.

The controller can be configured to determine, on the basis of the current bicycle transmission ratio, and the first next higher or first next lower bicycle transmission ratio to be switched to which one(s) of the first transmission and the second transmission should be activated to change its gear ratio. It will be appreciated that an upshift to the first next higher bicycle transmission ratio of the bicycle transmission may involve a downshift of the gear ratio of one of the first or second transmission in combination with an upshift of the gear ratio of the other one of the first and second transmission. Similarly, a downshift to the first next lower bicycle transmission ratio of the bicycle transmission may involve an upshift of the gear ratio of one of the first or second transmission in combination with a downshift of the gear ratio of the other one of the first and second transmission. The controller thus controls one or more shift actuators of the bicycle transmission in response to the upshift or downshift command provided by the cyclist. Depending on the transmission ratio used at that point in time, the next higher bicycle transmission ratio can be obtained by actuating one or more shift actuators. The controller may be configured to select and actuate the appropriate shift actuator. For example, a gearshift to the next higher bicycle transmission ratio may involve a gearshift with e.g. an internal hub transmission as well as with e.g. a rear derailleur, whereas the user needs to make only one gearshift command, as the controller activates both the shift actuators accordingly. Shifting is thus simplified for the user. The one or more shift actuators can be arranged for being operated electronically by the controller. The bicycle transmission can be arranged such that the bicycle transmission ratios through which can be shifted can be chosen or adapted by the user.

Optionally, the second transmission comprises a continuously variable transmission that is used to switch, or shift, from a discrete second transmission ratio to another discrete second transmission ratio. While switching between the discrete second transmission ratios, the continuously variable transmission can traverse all (continuous) intermediate transmission ratios. The continuously variable transmission can be used to switch between three, or more, second transmission ratios. The continuous variable transmission may be arranged to operate according to a discrete transmission. For example, the continuous transmission may be preprogrammed to operate in a discrete manner according to the two or more second transmission ratios. The transmission ratios of the continuous variable transmission may be adapted and/or customized by a user, e.g. using a communication device such as smart phone table or (bicycle) computer.

The second transmission ratios can be chosen by the controller and possibly preprogrammed by the user. The user can e.g. select desired second transmission ratios and set these in the controller, e.g. by creating a control program. Thereto, the controller can be operatively connected to, or include, a user interface. The user interface may be part of a bicycle computer. The bicycle computer may be a releasably coupled to the handlebar. The user interface may be powered by the same power source, e.g. battery module, as the control device and other electric components. The user interface may also show the battery status of the battery module. It is also possible that the second transmission ratios are selected on a communications device, such as a smartphone or tablet, and communicated to the controller. A computer program product, such as an app, can thereto be executed on the communications device.

The second transmission ratio(s) can be chosen by the controller and can be adapted depending on the sprocket that is engaged with the chain of the first transmission. It is also possible that the user preprograms second transmission ratios depending on the sprocket that can be engaged with the chain.

The bicycle transmission ratio is defined by the first and second transmissions, in particular by the respective gear ratios of the first and second transmissions. The first gear ratio of the first transmission need not be identical to the first gear ratio of the second transmission.

The the first transmission may include a set of sprockets, having varying numbers of teeth, such as a cassette. The number of teeth of the sprockets may increase from one sprocket to the next in a geometric order. The first transmission can include a chain driven by a chain ring and transferring torque from a system input, such as a crank, to one of the sprockets. The bicycle transmission, particularly the second transmission thereof, may include a planetary gear set.

The first actuator and/or the second actuator can be an electric actuator, derailleur system or a clutch or brake device.

According to an aspect is provided an assembly comprising a bicycle handlebar including left and right grip portion for allowing a user to grip the handle bar with its respective a left and right hand, and a bicycle transmission control system as described hereinabove. The first control device can be mounted to the handlebar at or near the right grip portion and the second control device can be mounted to the handlebar at or near the left grip portion, or vice versa wherein the first control device is mounted to the handlebar at or near the left grip portion and the second control device is mounted to the handlebar at or near the right grip portion.

Optionally, the controller is fixable to or integratable in the bicycle handlebar. The controller and/or the transmitter and/or the power source can form a single module, e.g. configured to be placed in the end of the bicycle handlebar.

According to an aspect is provided a bicycle comprising a bicycle transmission control system as described hereinabove.

It will be appreciated that actuation of the sensing device may involve opening and/or closing of an electric circuit. For example, the sensing device can be actuated upon arrival of the user contact surface at an actuation position. It is also possible that the sensing device is actuated upon departure of the user contact surface from the actuation position. It is furthermore possible that the sensing device is actuated by the user contact surface upon arrival at and/or upon departure from a neutral position. The actuation of the sensing device may trigger the transmission of a signal, e.g. an electric or electronic signal. This signal may be received by a controller, actuator or other device.

Optionally, the user contact surface is movably, such as slidably or pivotably connected to a support body.

Optionally, the user contact surface is biased in the neutral position. The neutral position may correspond to a position in which the user contact surface does not actuate the sensing device. An elastic return member may for example be provided for returning the user contact surface from the actuation position to the neutral position.

Optionally, the sensing device is fixed to a brake lever assembly. The sensing device may for example be integrated in the brake lever support body or the brake lever.

The controller is configured for generating a shift signal for initiating a gearshift. The shift signal is preferably an electronic signal, such as a wired or wireless electronic signal. The shift signal may be generated by means of an electronic switch of the sensing device, e.g. by opening or closing an electric circuit, and/or by providing a pulsed signal. The shift signal can be transmitted to an actuator of the bicycle transmission, e.g. using a wireless and/or wired connection.

It will be appreciated that any one or more of the above aspects, features and options can be combined. It will be appreciated that any one of the options described in view of one of the aspects can be applied equally to any of the other aspects. It will also be clear that all aspects, features and options described in view of the bicycle transmission control system apply equally to the assembly and bicycle.

### BRIEF DESCRIPTION OF THE DRAWING

The invention will further be elucidated on the basis of exemplary embodiments which are represented in a drawing. The exemplary embodiments are given by way of non-limitative illustration. It is noted that the figures are only schematic representations of embodiments of the invention that are given by way of non-limiting example.

In the drawing:

FIG. 1 shows an example of a bicycle transmission control system;

FIG. 2 shows an example of a bicycle transmission control system;

FIG. 3 shows an example of a bicycle transmission control system;

FIG. 4 shows an example of a bicycle transmission control system;

FIG. 5 shows an example of a bicycle transmission control system;

FIG. 6 shows an example of a bicycle.

### DETAILED DESCRIPTION

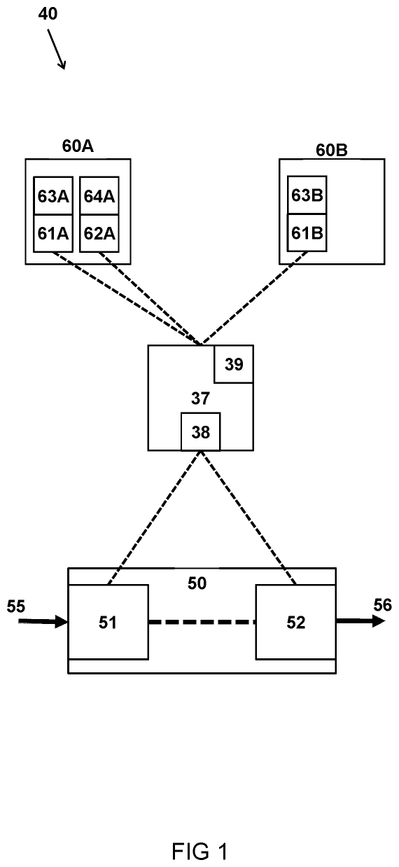

FIG. 1 shows a schematic example of a bicycle transmission control system 40 for controlling a bicycle transmission 50 having a plurality of consecutive discrete bicycle transmission ratios.

In this example, the bicycle transmission 50 includes a first transmission 51 connected in series to a second transmission 52. The first transmission 51 here includes a plurality of sprockets associated with an endless drive member, such as a chain, and an electrically actuatable derailleur. The electrically actuatable derailleur includes a first shift actuator. The plurality of sprockets can e.g. be formed as a cassette. The first transmission can e.g. comprise four, five, six, seven, eight, nine, or ten sprockets, although other numbers are also possible. The first transmission 51 provides a plurality of selectable first transmission ratios by selecting which sprocket the endless drive member engages. The second transmission 52 here includes an electrically actuatable internal hub transmission having two selectable second transmission ratios. The electrically actuatable internal hub transmission includes a second shift actuator. In this example, a first transmission ratio step size from one first transmission ratio to the next is smaller than a second transmission ratio step size from the first second transmission ratio to the second second transmission ratio. The bicycle transmission 50, including the first transmission 51 and the second transmission 52 here provides a plurality of consecutive discrete bicycle transmission ratios. An input 55 of the transmission 50 can be can be connected to a bicycle crank. An output 56 of the transmission 50 can be connected to a driven wheel hub.

In this example, the bicycle transmission control system 40 comprises a first control device 60A comprising a first sensing device 61A and a second sensing device 62A. Here, the first sensing device 61A is actuatable through a first user contact surface 63A, and the second sensing device 62A is actuatable through a second user contact surface 64A different from the first user contact surface 63A. The bicycle transmission control system 40 in this example comprises a second control device 60B comprising a third sensing device 61B. Here, the third sensing device 61B is actuatable through a third user contact surface 63B. In this example, the sensing devices 61A, 61B, 62A are electric contact switches, and the user contact surfaces 63A, 63B, 64A are push buttons, such that depressing of the push buttons actuates the corresponding electric contact switch. However, the user contact surfaces can also be differently embodied, such as touch pads, rocker switches, sliders, levers, grip shifters or the like. It will be appreciated that the first sensing device 61A and the second sensing device 62A may be integrated into a single sensing unit configured to sense a first user input and a different second user input. Also, the sensing devices can be embodied differently, such as magnetic sensors, capacitive sensors, etc.

The bicycle transmission control system 40 comprises a controller 37 that is operatively connected to the sensing devices 61A, 61B, 62A of the first and second control devices 60A, 60B. The controller 37 is configured to control the bicycle transmission 50 to activate a gear shift upon actuation of one of the first, second, or third sensing devices.

In this example, the controller 37 is configured to control the bicycle transmission 50 to activate a gear upshift to the first next higher bicycle transmission ratio upon actuation of the first sensing device 61A. In this example, the controller 37 is configured to control the bicycle transmission 50 to activate a gear downshift to the first next lower bicycle transmission ratio upon actuation of the second sensing device 62A.

In this example, the controller 37 is configured to determine, on the basis of the current bicycle transmission ratio, and the first next higher or first next lower bicycle transmission ratio to be switched to, which one(s) of the first transmission 51 and the second transmission 52 should be activated to change its gear ratio. It will be appreciated that an upshift to the first next higher bicycle transmission ratio of the bicycle transmission 50 may involve a downshift of the gear ratio of one of the first or second transmission 51, 52 in combination with an upshift of the gear ratio of the other one of the first and second transmission 51, 52. Similarly, a downshift to the first next lower bicycle transmission ratio of the bicycle transmission 50 may involve an upshift of the gear ratio of one of the first or second transmission 51, 52 in combination with a downshift of the gear ratio of the other one of the first and second transmission 51, 52. The controller 37 thus controls one or more shift actuators of the bicycle transmission 50 in response to the upshift or downshift command provided by the cyclist. Depending on the bicycle transmission ratio used at that point in time, the next higher bicycle transmission ratio can be obtained by actuating one or more shift actuators. The controller may be configured to select and actuate the appropriate shift actuator(s) of the first and second transmission. For example, a gearshift to the next higher bicycle transmission ratio may involve a gearshift with the internal hub transmission 52, 1022 as well as with e.g. a rear derailleur 51, 1024, whereas the user needs to make only one gearshift command, as the controller activates both the shift actuators accordingly. Shifting is thus simplified for the user. The one or more shift actuators can be arranged for being operated electronically by the controller. The bicycle transmission 50 can be arranged such that the bicycle transmission ratios through which can be shifted can be chosen or adapted by the user.

In this example, the controller 37 is configured to control the bicycle transmission 50 to control only the second transmission 52, here the electrically actuatable internal hub transmission, to activate a gear shift upon actuation of the third sensing device 61B. The gearshift of the second transmission 52 in this example is from the present second transmission ratio to the other second transmission ratio. Hence, upon actuation of the third sensing device 61B in this example the second transmission 52 can either shift up or shift down, depending on the present second transmission ratio. In this example, a first transmission ratio step size from one first transmission ratio to the next is smaller than a second transmission ratio step size from the first second transmission ratio to the second second transmission ratio. Therefore, actuation of the third sensing device can cause a change in bicycle transmission ratio that is larger than a change to the first next higher or first next lower bicycle transmission ratio.

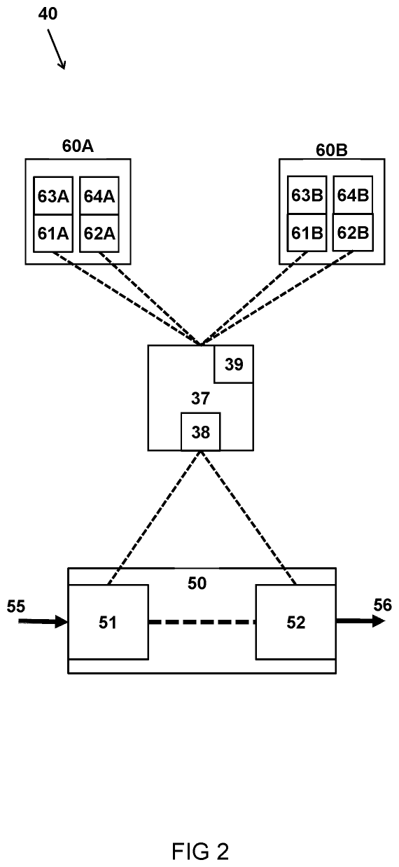

FIG. 2 shows a schematic example of a bicycle transmission control system 40 for controlling a bicycle transmission 50 having a plurality of consecutive discrete bicycle transmission ratios, similar to the example of FIG. 1.

In this example, the bicycle transmission 50 includes a first transmission 51 connected in series to a second transmission 52. The first transmission 51 here includes a plurality of sprockets associated with an endless drive member, such as a chain, and an electrically actuatable derailleur. The electrically actuatable derailleur includes a first shift actuator. The plurality of sprockets can e.g. be formed as a cassette. The first transmission can e.g. comprise four, five, six, seven, eight, nine, or ten sprockets, although other numbers are also possible. The first transmission 51 provides a plurality of selectable first transmission ratios by selecting which sprocket the endless drive member engages. The second transmission 52 here includes an electrically actuatable internal hub transmission having at least two, preferably more than two, selectable transmission ratios. The electrically actuatable internal hub transmission includes a second shift actuator. In this example, a first transmission ratio step size from one first transmission ratio to the next is smaller than a second transmission ratio step size from one second transmission ratio to next second transmission ratio. The bicycle transmission 50, including the first transmission 51 and the second transmission 52 here provides a plurality of consecutive discrete bicycle transmission ratios. An input 55 of the transmission 50 can be can be connected to a bicycle crank. An output 56 of the transmission 50 can be connected to a driven wheel hub.

In this example, the bicycle transmission control system 40 comprises a first control device 60A comprising at least a first sensing device 61A and a second sensing device 62A. Here, the first sensing device 61A is actuatable through a first user contact surface 63A, and the second sensing device 62A is actuatable through a second user contact surface 64A different from the first user contact surface 63A. The bicycle transmission control system 40 in this example comprises a second control device 60B comprising at least a third sensing device 61B and fourth sensing device 62B. Here, the third sensing device 61B is actuatable through a third user contact surface 63B, and the fourth sensing device 62B is actuatable through a fourth user contact surface 64B different from the third user contact surface 63B. In this example, the sensing devices 61A, 61B, 62A, 62B are electric contact switches, and the user contact surfaces 63A, 63B, 64A, 64B are push buttons, such that depressing of the push buttons actuates the corresponding electric contact switch. However, the user contact surfaces can also be differently embodied, such as touch pads, rocker switches, sliders, levers, grip shifters or the like. It will be appreciated that the first sensing device 61A and the second sensing device 62A may be integrated into a single sensing unit configured to sense a first user input and a different second user input. Similarly, the third sensing device 61B and the fourth sensing device 62B may be integrated into a single sensing unit configured to sense a third user input and a different fourth user input. Also, the sensing devices can be embodied differently, such as magnetic sensors, capacitive sensors, etc.

The bicycle transmission control system 40 comprises a controller 37 that is operatively connected to the sensing devices 61A, 61B, 62A, 62B of the first and second control devices 60A, 60B. The controller 37 is configured to control the bicycle transmission 50 to activate a gear shift upon actuation of one of the first, second, third or fourth sensing devices.

In this example, the controller 37 is configured to control the bicycle transmission 50 to activate a gear upshift to the first next higher bicycle transmission ratio upon actuation of the first sensing device 61A. In this example, the controller 37 is configured to control the bicycle transmission 50 to activate a gear downshift to the first next lower bicycle transmission ratio upon actuation of the second sensing device 62A.

In this example, the controller 37 is configured to determine, on the basis of the current bicycle transmission ratio, and the first next higher or first next lower bicycle transmission ratio to be switched to, which one(s) of the first transmission 51 and the second transmission 52 should be activated to change its gear ratio. It will be appreciated that an upshift to the first next higher bicycle transmission ratio of the bicycle transmission 50 may involve a downshift of the gear ratio of one of the first or second transmission 51, 52 in combination with an upshift of the gear ratio of the other one of the first and second transmission 51, 52. Similarly, a downshift to the first next lower bicycle transmission ratio of the bicycle transmission 50 may involve an upshift of the gear ratio of one of the first or second transmission 51, 52 in combination with a downshift of the gear ratio of the other one of the first and second transmission 51, 52. The controller 37 thus controls one or more shift actuators of the bicycle transmission 50 in response to the upshift or downshift command provided by the cyclist. Depending on the bicycle transmission ratio used at that point in time, the next higher bicycle transmission ratio can be obtained by actuating one or more shift actuators. The controller may be configured to select and actuate the appropriate shift actuator(s) of the first and second transmission. For example, a gearshift to the next higher bicycle transmission ratio may involve a gearshift with the internal hub transmission 52, 1022 as well as with e.g. a rear derailleur 51, 1024, whereas the user needs to make only one gearshift command, as the controller activates both the shift actuators accordingly. Shifting is thus simplified for the user. The one or more shift actuators can be arranged for being operated electronically by the controller. The bicycle transmission 50 can be arranged such that the bicycle transmission ratios through which can be shifted can be chosen or adapted by the user.

In this example, the controller 37 is configured to control the bicycle transmission 50 to control only the second transmission 52, here the electrically actuatable internal hub transmission, to activate a gear upshift upon actuation of the third sensing device. In this example, the controller 37 is configured to control the bicycle transmission 50 to control only the second transmission 52, here the electrically actuatable internal hub transmission, to activate a gear downshift to a lower second transmission ratio upon actuation of the fourth sensing device.

In the example of FIGS. 1 and 2, the controller 37 includes a transmitter 38 for wirelessly transmitting a gear shift command to the bicycle transmission system 50. The transmitter may include an antenna for transmitting a wireless signal. It will be appreciated that the transmitter may be considered to be part of the controller and/or of the control device. The controller may communicate with the first and/or second actuator, by means of the transmitter. The controller may for instance transmit, with the transmitter, a control signal that is associated with an upshift command to the first and/or second actuator, which actuator, in response to the control signal, brings about an upward gearshift. The controller may transmit multiple control signals to multiple actuators simultaneously and/or sequentially, e.g. in response to a single signal received from the sensing device. The control signal is preferably transmitted by the transmitter wirelessly, but it will be appreciated that the control signal can also be transmitted by wire.

In these examples, the controller 37 includes an electric power source 39, here a battery.

In these examples, the first control device 60A is configured to be operable with a user's right hand and the second control device 60B is configured to be operable with the user's left hand. It will be clear that it is also possible that the first control device 60A is configured to be operable with a user's left hand and the second control device 60B is configured to be operable with the user's right hand. Hence, the user has full bimanual control over the transmission system at all times.

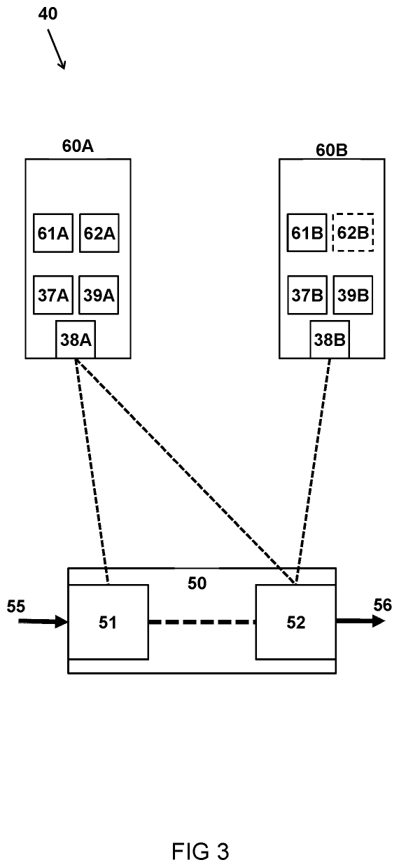

FIG. 3 shows a schematic example of a bicycle transmission control system 40 for controlling a bicycle transmission 50 having a plurality of consecutive discrete bicycle transmission ratios, similar to the examples of FIGS. 1 and 2.

In the example of FIG. 3, the first control device 60A includes, or is placed in a common housing with, a first controller 37A. The first control device 60A can include a first transmitter 38A for wirelessly transmitting a gear shift command to the bicycle transmission system 50. The first control device 60A can include a first electric power source 39A, here a battery. In the example of FIG. 3, the second control device 60B includes, or is placed in a common housing with, a second controller 37B. The second control device 60B can include a second transmitter 38B for wirelessly transmitting a gear shift command to the bicycle transmission system 50. The second control device 60B can include a second electric power source 39B, here a battery. The first controller 37A and the second controller 37B together form a controller 37 of the control system. The first controller 37A is configured to control the first and second transmission 51, 52. The first controller 37A is configured to, upon actuation of the first sensing device 61A control the first and/or second transmission 51, 52 to activate a gear upshift to the first next higher bicycle transmission ratio. The first controller 37A is configured to, upon actuation of the second sensing device 61B control the first and/or second transmission 51, 52 to activate a gear downshift to the first next lower bicycle transmission ratio. Thereto, the first transmitter 38A may transmit a control signal to the first and/or second transmission 51, 52. It is also possible that the first transmitter transmits a control signal to the first transmission 51, and the first transmission relays a control signal to the second transmission 52 if required. It is also possible that the first transmitter transmits a control signal to the second transmission 52, and the second transmission relays a control signal to the first transmission 51 if required. The second controller 37B is configured to, upon actuation of the third sensing device 61B control only the second transmission 52 to activate a gear shift. In this example, the fourth sensing device 62B is optional. The second controller 37B can be configured to, upon actuation of the third sensing device 61B control only the second transmission 52 to activate a gear upshift, and, upon actuation of the fourth sensing device 62B, control only the second transmission 52 to activate a gear downshift. Thereto, the second transmitter 38B may transmit a control signal to the second transmission 52. It is also possible that the second transmitter 38B transmits a control signal to the first transmission 51, and the first transmission relays the control signal to the second transmission 52.

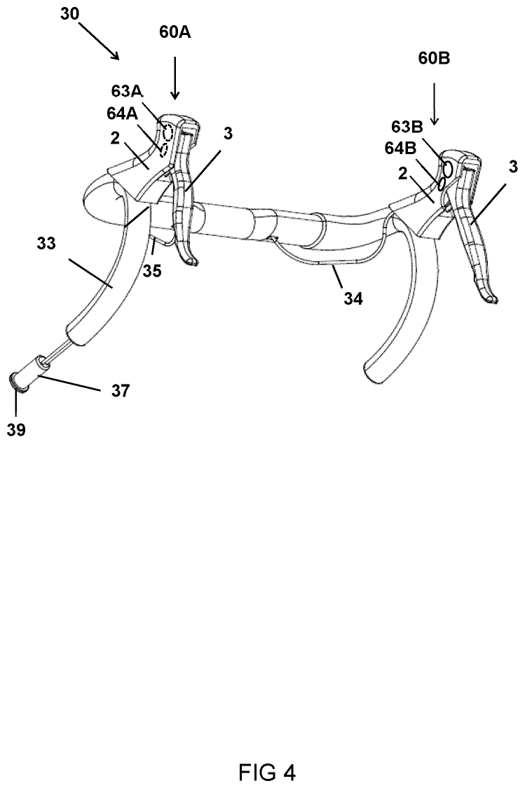

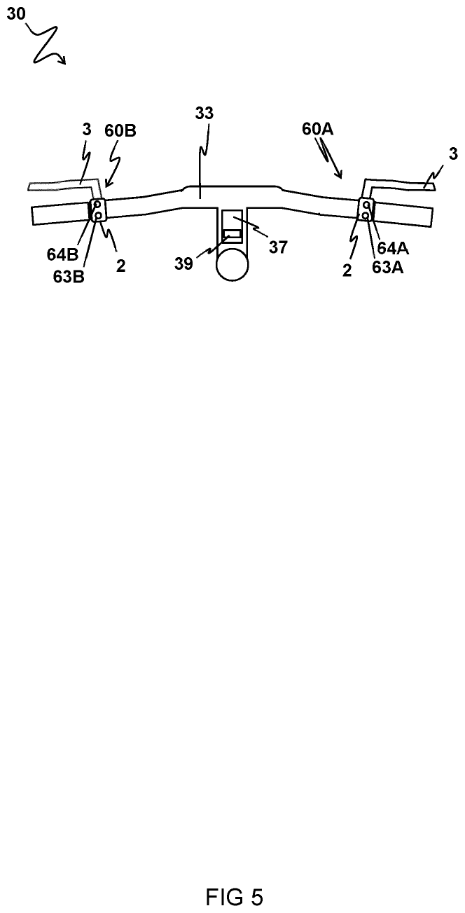

As shown in the examples of FIGS. 4 and 5, the first control device 60A can be configured to be mounted at a bicycle handlebar right grip portion and the second control device 60B can be configured to be mounted at a bicycle handlebar left grip portion. Alternatively, the first control device can be configured to be mounted at a bicycle handlebar left grip portion and the second control device can be configured to be mounted at a bicycle handlebar right grip portion.

FIG. 4 shows a perspective view of an assembly 30, comprising a handlebar 33 of a bicycle, in this a case drop handlebar of a road or gravel race bicycle. A first and a second control device 60A, 60B are mounted to the handlebar 33, at a respective right and left grip portion of the handlebar 33, when used by the cyclist. The first and second control device 60A, 60B are substantially mirrored with respect to one another here. Here, the sensing devices 61A, 61B, 62A, 62B are mounted to the support bodies 2 of the brake levers 3. The user contact surfaces 63A, 63B, 64A, 64B are here in the form of push buttons.

The controller 37 is provided, in this example, in an end section of the handlebar 33. In this example, the controller 37 and the transmitter 38 and the power source 39 form a single module, here configured to be placed in the end of the bicycle handlebar.

Here, each sensing device, i.e. the sensing device of the first control device 60A, and the sensing device of the second control device 60B, is connected to the controller 37 by means of a respective wire 34, 35. Said connection may alternatively be wirelessly. Here, the wires 34, 35 at least partly run through a cavity of the handlebar 33. The controller 37 comprises the transmitter 39, which transmitter 39 is arranged to transmit a wireless signal. The transmitter 39 is particularly arranged to transmit a wireless signal to an actuator of a transmission system 50 to activate a transmission ratio shift.

FIG. 5 shows a further example of an assembly 30 comprising a handlebar 33 of a bicycle, in this case a flat-bar handlebar of a mountain bike or commuter bike. A first and a second control device 60A, 60B are mounted to the handlebar 33, at a respective right and left grip portion of the handlebar 33. The user contact surfaces 63A, 63B, 64A, 64B are here in the form of push buttons.

In these examples, the controller 37 is configured to control the bicycle transmission 50 to activate a gear change in:
only the first transmission 51,
only the second transmission 51, or
both the first and the second transmission 51, 52,
   upon actuation of the first or second sensing device 61A, 61B. The controller 37 can be configured to determine, on the basis of the current bicycle transmission ratio, and the first next higher or first next lower bicycle transmission ratio to be switched to which one(s) of the first transmission 51 and the second transmission 52 should be activated to change its gear ratio. It will be appreciated that an upshift to the first next higher bicycle transmission ratio of the bicycle transmission 50 may involve a downshift of the gear ratio of one of the first or second transmission in combination with an upshift of the gear ratio of the other one of the first and second transmission. Similarly, a downshift to the first next lower bicycle transmission ratio of the bicycle transmission may involve an upshift of the gear ratio of one of the first or second transmission in combination with a downshift of the gear ratio of the other one of the first and second transmission. The controller 37 thus controls one or more shift actuators of the transmission system 50 in response to the upshift or downshift command provided by the cyclist. Depending on the bicycle transmission ratio used at that point in time, the next higher bicycle transmission ratio can be obtained by actuating one or more shift actuators. The controller may be configured to select and actuate the appropriate shift actuator. For example, a gearshift to the next higher bicycle transmission ratio may involve a gearshift with e.g. an internal hub 52, 1022 transmission as well as with e.g. a rear derailleur 1024, whereas the user needs to make only one gearshift command, as the controller activates both the shift actuators accordingly. Shifting is thus simplified for the user. The one or more shift actuators can be arranged for being operated electronically by the controller. The transmission system can be arranged such that the transmission ratios through which can be shifted can be chosen or adapted by the user.

Optionally, the controller is configured to control the bicycle transmission to activate a gear change in only the second transmission upon actuation of the third or fourth sensing device. The controller may e.g. be configured to control the bicycle transmission to activate a gear change in only the hub transmission upon actuation of the third or fourth sensing device.

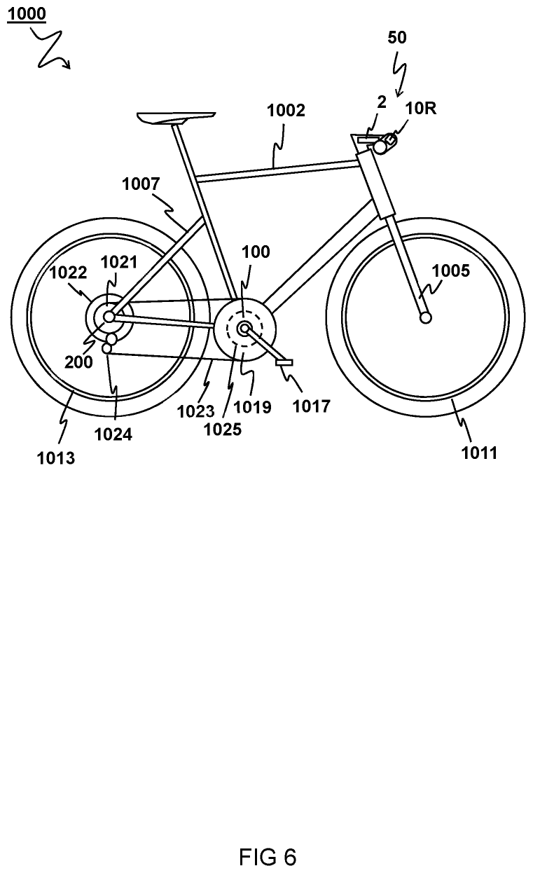

FIG. 6 shows a bicycle 1000. The bicycle 1000 comprises a frame 1002 with a front fork 1005 and a rear fork 1007, as well as a front wheel and a rear wheel 1011, 1013 located in the front and rear fork respectively. The bicycle 1000 further comprises a crank 1017, and a front chain wheel 1019. The bicycle 1000 also comprises a plurality of rear sprockets 1021 and an internal transmission rear wheel hub 1022 of the rear wheel 1013, wherein a chain or belt 1023 threads over the front chain wheel 1019, one of the rear sprockets 1021 and the derailleur 1024. In this example, the bicycle 1000 comprises a first transmission 51, which is formed by the chain 1023 and the rear sprockets 1021, and a second transmission 52 which is formed by the internal transmission rear wheel hub 1022. The first transmission 51 is operable according to multiple transmission ratios and includes a first gearshift actuator, here electronic derailleur actuator, for actuating a gear shift with the first transmission 51. The second transmission 52 is also operable according to multiple transmission ratios and includes a second gearshift actuator, here electronic internal gear hub actuator, for actuating a gear shift with the second transmission 52.

In the examples, the second transmission is formed by an internal transmission rear wheel hub. It will be appreciated that it is also possible that the second transmission is formed by an internal transmission crank unit 1025, shown as optional in dashed line in FIG. 6.

In the examples, the controller 37 is configured to control the bicycle transmission 50 to activate a gear upshift to the first next higher bicycle transmission ratio upon actuation of the first sensing device 61A and to control the bicycle transmission 50 to activate a gear downshift to the first next lower bicycle transmission ratio upon actuation of the second sensing device 62A. It is also possible that the controller 37 is configured to control the bicycle transmission 50 to activate a gear upshift to the first next higher bicycle transmission ratio upon actuation of the first sensing device 61A and to control the bicycle transmission 50 to activate a gear downshift to the first next lower bicycle transmission ratio upon actuation of the third sensing device 62A.

In the examples of FIGS. 2-6, the controller 37 is configured to control only the second transmission 52 to activate a gear upshift upon actuation of the third sensing device and to control only the second transmission 52 to activate a gear downshift to a lower second transmission ratio upon actuation of the fourth sensing device. It is also possible that the controller 37 is configured to control the bicycle transmission 50 to activate a gear upshift to a bicycle transmission ratio higher than the first next higher bicycle transmission ratio upon actuation of the third sensing device and to control the bicycle transmission 50 to activate a gearshift to a lower bicycle transmission ratio lower than first next lower bicycle transmission ratio upon actuation of the fourth sensing device. For example, the controller can be configured to control the bicycle transmission to activate a gear upshift to the second, third, fourth, fifth or sixth next higher transmission ratio upon actuation of the third sensing device. The controller can be configured to control the bicycle transmission to activate a gear downshift to the second, third, fourth, fifth or sixth next lower transmission ratio upon actuation of the fourth sensing device. The controller may be configured to allow user setting of which transmission ratio step the third and fourth sensing device are associated with, e.g. using an app on a mobile device, such as a smartphone.

It will be appreciated that it is also possible that the controller 37 is configured to control only the second transmission 52 to activate a gear upshift upon actuation of the second sensing device and to control only the second transmission 52 to activate a gear downshift to a lower second transmission ratio upon actuation of the fourth sensing device. It is also possible that the controller 37 is configured to control the bicycle transmission 50 to activate a gear upshift to a bicycle transmission ratio higher than the first next higher bicycle transmission ratio upon actuation of the second sensing device and to control the bicycle transmission 50 to activate a gearshift to a lower bicycle transmission ratio lower than first next lower bicycle transmission ratio upon actuation of the fourth sensing device.

Herein, the invention is described with reference to specific examples of embodiments of the invention. It will, however, be evident that various modifications, variations, alternatives and changes may be made therein, without departing from the essence of the invention. For the purpose of clarity and a concise description features are described herein as part of the same or separate embodiments, however, alternative embodiments having combinations of all or some of the features described in these separate embodiments are also envisaged and understood to fall within the framework of the invention as outlined by the claims. The specifications, figures and examples are, accordingly, to be regarded in an illustrative sense rather than in a restrictive sense. The invention is intended to embrace all alternatives, modifications and variations which fall within the spirit and scope of the appended claims. Further, many of the elements that are described are functional entities that may be implemented as discrete or distributed components or in conjunction with other components, in any suitable combination and location.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. A bicycle transmission control system for controlling a bicycle transmission having a plurality of consecutive discrete bicycle transmission ratios, the bicycle transmission comprising a first transmission connected in series to a second transmission, wherein:
the first transmission includes a plurality of sprockets associated with an endless drive member, such as a chain, and an electrically actuatable derailleur; and
the second transmission includes an electrically actuatable internal hub transmission or internal crank transmission having at least two selectable transmission ratios;
the control system comprising:
a first, a second, and a third sensing device; and
a controller that is operatively connected to the first, second, and third sensing devices, wherein the controller is configured to control the bicycle transmission to activate a gear shift upon actuation of one of the first, second or third sensing devices;
wherein the controller is configured to:
upon actuation of the first sensing device control the first and/or second transmission to activate a gear upshift to the first next higher bicycle transmission ratio;
upon actuation of the second sensing device control the first and/or second transmission to activate a gear downshift to the first next lower bicycle transmission ratio; and
upon actuation of the third sensing device control only the second transmission to activate a gear shift.

2. The bicycle transmission control system of claim 1, further comprising a fourth sensing device, wherein the controller is configured to:
upon actuation of the third sensing device control only the second transmission to activate a gear upshift; and
upon actuation of the fourth sensing device control only the second transmission to activate a gear downshift.

3. The bicycle transmission control system of claim 1, wherein
the first sensing device is actuatable through a first user contact surface;
the second sensing device is actuatable through a second user contact surface different from the first user contact surface; and
the third sensing device is actuatable through a third user contact surface different from the first and second user contact surfaces; and, if present,
the fourth sensing device is actuatable through a fourth user contact surface different from the first, second and third user contact surface.

4. The bicycle transmission control system of claim 1, comprising
a first control device comprising the first sensing device and the second sensing device; and
a second control device comprising the third and, if present, the fourth sensing device.

5. The bicycle transmission control system of claim 4, wherein the first control device is configured to be operable with a user's right hand and the second control device is configured to be operable with the user's left hand, or vice versa.

6. The bicycle transmission control system of claim 5, wherein the first control device is configured to be mounted at a bicycle handlebar right grip portion and the second control device is configured to be mounted at a bicycle handlebar left grip portion, or vice versa.

7. The bicycle transmission control system of claim 3, wherein the first user contact surface includes a first user actuatable button, the second user contact surface includes a separate second user actuatable button, and the third user contact surface includes a separate third user actuatable button, and, if present, the fourth user contact surface includes a separate fourth user actuatable button.

8. The bicycle transmission control system of claim 4, the first control device is a grip shifter; and/or
the second control device is a grip shifter.

9. The bicycle transmission control system of claim 1, wherein the controller is fixable to or integratable in a bicycle handlebar.

10. The bicycle transmission control system of claim 1, wherein the controller is configured to be mounted in an end of a bicycle handlebar.

11. The bicycle transmission control system of claim 1, wherein the controller includes or is connected to a transmitter for wirelessly transmitting a gear shift command to the bicycle transmission system.

12. The bicycle transmission control system of claim 1, wherein the controller includes or is connected to an electric power source or a battery.

13. The bicycle transmission control system of claim 1, wherein the first and a second control devices are wiredly connected to the controller.

14. An assembly comprising a bicycle handlebar including a left and a right grip portion for allowing a user to grip the bicycle handle bar with its respective a left and right hand, and the bicycle transmission control system in accordance with claim 1.

15. The assembly of claim 14, wherein the bicycle transmission control system is according to claim 4, wherein the first control device is mounted to the bicycle handlebar at or near the right grip portion and the second control device is mounted to the bicycle handlebar at or near the left grip portion, or vice versa.

16. The assembly according to claim 14, wherein the controller is fixable to or integratable in the bicycle handlebar.

17. A bicycle comprising a bicycle transmission control system according to claim 1.
